(19) United States
(12) Patent Application Publication
(10) Pub. No.: US 2016/0251873 A1
(43) Pub. Date: Sep. 1, 2016

(54) A FENCE POST AND FENCING SYSTEM

(71) Applicants: Margaret Ann BURNS, Clarkefield, Victoria (AU); Peter Michael BURNS, Clarkefield, Victoria (AU)

(72) Inventor: Peter Michael Burns, Clarkefield (AU)

(21) Appl. No.: 15/028,514

(22) PCT Filed: Oct. 10, 2014
(86) PCT No.: PCT/AU2014/000967

§ 371 Date: Apr. 11, 2016

(30) Foreign Application Priority Data
Oct. 11, 2013 (AU) 2013903919

(51) Int. Cl. E04H 17/12; E04H 17/08; A01K 3/00; E04H 17/04

(52) U.S. Cl. CPC E04H 17/12; E04H 17/04; E04H 17/08; A01K 3/00

(57) ABSTRACT

A fence post including a body portion having an external surface and a longitudinal axis extending substantially the length of the fence post and at least one continuous opening extending transversely across the body portion, the opening having a first end and a second end, the first end being located proximal to a first side of the body portion and the second end being located proximal to a second side of the body portion which opposes the first side of the body portion, wherein the first and second ends of the opening are connected to the external surface of the body portion via a primary slot.

### FIELD OF THE INVENTION

The present invention relates generally to fence posts and fencing systems. The invention relates particularly to fence posts for use in rural fencing for containing livestock and excluding pests, but may also find application in other types of fencing such as temporary fencing for building sites, barriers on roadside verges and barriers for diverting pedestrian traffic, and the like.

### BACKGROUND TO THE INVENTION

Rural type fencing typically involves timber posts having a length of fencing wire, being plain, barbed or ring-lock, fixed to the timber post using U-nails or similar fixture means. Alternatively, steel posts, commonly referred to as star pickets, are frequently used when a more cost effective means of erecting a fence is required. Such steel posts include a series of apertures through which a plain wire can be passed. Where steel posts are used to support a ring-lock fence, the length of ring-lock is typically secured to a top and a bottom plain wire strung through the apertures provided in the steel posts, generally using short lengths of tie-wire or fence clips to secure the ring-lock to the top and bottom plain wires.

Such fence structures permit some level of straining of the wire fence to increase tension thereof post erection of the fence, but straining is limited to the extent that some sections of the fencing wire may be fixedly secured to, for instance, a timber post, and also by attachment of the ring-lock to the plain wire which may otherwise be able to slide through the apertures in the steel posts, will limit the extent of straining that can occur post erection of the fence.

Furthermore, it can be quite time consuming to erect a fence in the above described manner, and also requires and ample supply of tie wire and/or U-nails or other fixing means.

The present invention therefore desires to provide an alternative to existing fence posts which may ameliorate at least some of the limitations of prior art fence posts. Other advantages of the invention will become apparent to those of ordinary skill in the art having reference to the following specification together with its drawings.

### SUMMARY OF THE INVENTION

According to an aspect of the present invention, there is provided a fence post including: a body portion having an external surface and a longitudinal axis extending substantially the length of the fence post; at least one continuous opening extending transversely across the body portion, the opening having a first end and a second end, the first end being located proximal to a first side of the body portion and the second end being located proximal to a second side of the body portion which opposes the first side of the body portion, wherein the first and second ends of the opening are connected to the external surface of the body portion via a primary slot.

Preferably, the primary slot slants across the body portion relative to the opening.

The primary slot may slant across the body portion such that the primary slot connects a first point located on the first end of the opening continuously with a second point located on the second end of the opening, wherein the first point is diametrically opposed to the second point.

Preferably, the primary slot connecting the first and second ends of the opening is configured to receive a fencing wire therein.

The primary slot may be connected to the first and second ends of the opening via a secondary slot extending substantially perpendicular to the primary slot.

Furthermore, the primary slot may be connected to the first and second ends of the opening via secondary slots extending axially along the external surface of the body portion.

The secondary slots may extend substantially along the length of the fence post along the external surface of the body portion.

In one embodiment the secondary slots have a depth of equal to or less than 10 mm.

In a preferred form of the present invention, the body portion includes a plurality of openings extending transversely across the body portion at intervals spaced along the length of the body portion.

The primary slot is preferably of sufficient width to permit fencing wire to be inserted through the primary slot into the opening.

In an embodiment, the body portion is formed of moulded polymeric material.

The body portion may be configured to be received in a steel extrusion substantially the length of the body portion, such that the external surface of the body portion including the opening and primary slot remains exposed.

According to another aspect of the present invention, there is provided a fence post including: a body portion having a an external surface and a longitudinal axis extending substantially the length of the fence post; at least one continuous opening extending transversely across the body portion, the opening being configured to receive a fencing wire therein in use, without requiring the fencing wire to be threaded through the opening from a first end of the opening being located proximal to a first side of the body portion to a second end of the opening being located proximal to a second side of the body portion which opposes the first side of the body portion; wherein the configuration of the opening further provides sufficient hold on the fencing wire to prevent it from escaping the opening while the fence post is in use.

According to yet another aspect of the present invention, there is provided a fencing system including: a plurality of fence posts, each fence post including: a body portion having a an external surface and a longitudinal axis extending substantially the length of the fence post; at least one continuous opening extending transversely across the body portion, the opening having a first end and a second end, the first end being located proximal to a first side of the body portion and the second end being located proximal to a second side of the body portion which opposes the first side of the body portion, wherein the first and second ends of the opening are connected to an external surface of the body portion via a primary slot; and at least one end assembly, the end assembly including: a first vertical member configured to secure the end assembly in a desired position; a second vertical member configured to be movable in axial relation to the first horizontal member; a support structure configured to maintain an upright position of the first vertical member while in use; wherein, the second vertical member includes a series of slots along it's length, the slots configured to receive fencing wire, and wherein securing an end of a length of wire fence proximal to the second vertical member enables straining of the length of wire fence with a single pull of the second vertical member towards the first vertical member.

The second vertical member may include at its base a guide portion which is configured to mount at least a portion of the substantially horizontal member to guide movement of the second vertical member during straining of the length of wire fence.

The second vertical member may further include a first attachment point located proximal to an elbow portion formed at the junction of two members extending laterally from the second vertical member.

In use, the first attachment point may be directed towards the first vertical member, and a connector may be joined between the first attachment point and a second attachment point located on the first vertical member, wherein the connector is adjustable in length to bring about an increase or decrease in tension along the length of wire fence.

In one embodiment, the connector comprises a chain-like member.

Alternatively, a ratchet system may be associated with the second vertical member and used to bring about an increase or decrease in tension along the length of wire fence.

The first vertical member may secure the end assembly in a desired position by: (a) having a base portion of the first vertical member embedded in the ground; or (b) securing the first vertical member to an existing structure.

### BRIEF DESCRIPTION OF THE DRAWINGS

It will be convenient to hereinafter describe the invention in greater detail by reference to the accompanying figures which facilitate understanding of the present invention. The particularity of the figures and the related description is not to be understood as superseding the generality of the broad identification of the invention as given in the attached claims.

FIG. 1 is an isometric view of a fence post in accordance with an embodiment of the present invention.

FIG. 2 is a side on view of the fence post of FIG. 1.

FIGS. 3A to 3C are cross sectional views of a fence post in accordance with different embodiments of the present invention.

FIGS. 4A to 4C are top down views of the fence posts of FIGS. 3A to 3C.

FIG. 5A is a front on view of an end assembly for use with the present invention.

FIG. 5B shows a top down view of the second vertical member of the end assembly according to FIG. 5A.

FIG. 6 is a side on view of the end assembly shown in FIG. 5.

FIG. 7 is an isometric view of a fence post shown adapted to be used on flood prone land.

### DETAILED DESCRIPTION

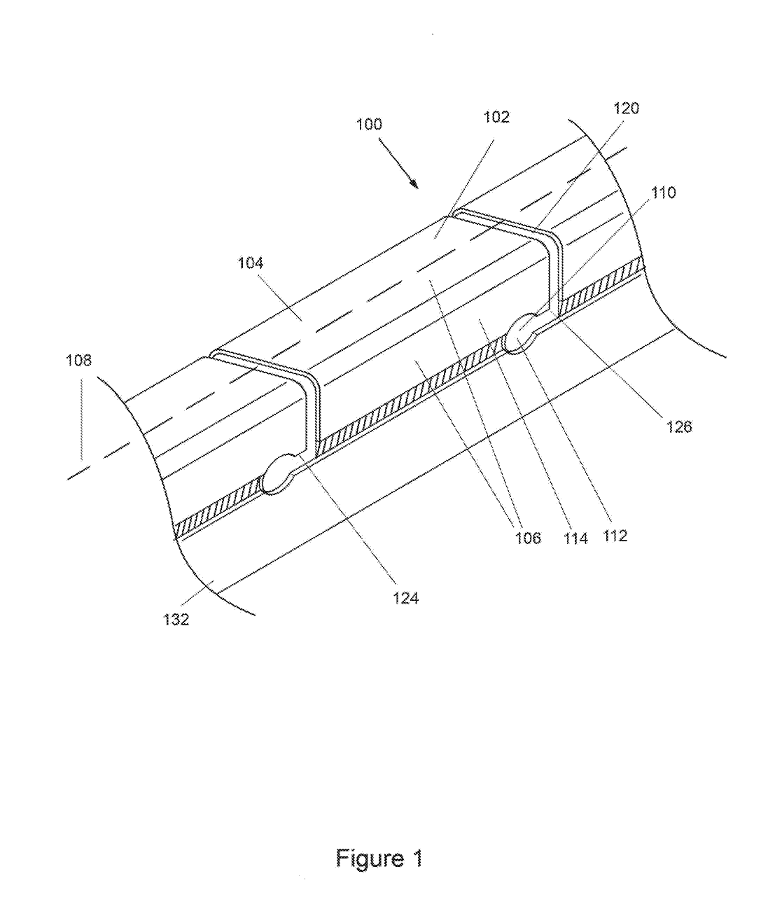

Referring firstly to FIG. 1, there is shown a fence post 100 in accordance with an embodiment. The fence post 100 includes a body portion 102. The body portion 102 may be any desirable shape but will generally have a substantially flat face 104 as shown in FIG. 1. The body portion 102 has an external surface, part of which is formed by the substantially flat face 104, and a longitudinal axis 108 which extends generally along the length of the fence post 100.

At least one continuous opening 110 comprising for instance, a substantially horizontal bore, extends transversely across the body portion 102. The opening 110 has two ends, a first end 112 which is located proximal to a first side 114 of the body portion 102 and a second end 116 which is located proximal to a second side 118 of the body portion. The first and second sides 114, 118 of the body portion 102 are opposing.

The first and second ends 112, 116 of the opening 110 are connected to the external surface 104 of the body portion 102 via a primary slot 120. The primary slot 120 is configured to receive a fencing wire therein to guide the fence wire (not shown) towards the opening 110 where it is removably secured by the configuration of the opening and primary slot in combination.

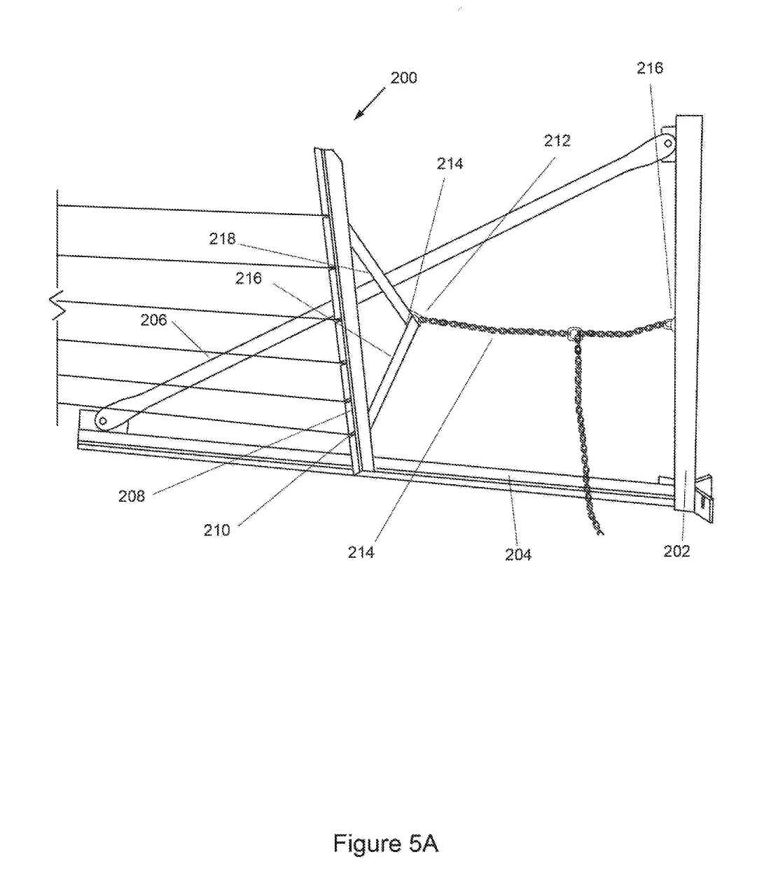

The primary slot 120 slants across the body portion 102 relative to the opening 110 (see FIGS. 4A to 4C). The slant or angle of the primary slot 120 with respect to the opening 110 generally provides a tab 124 of the body portion material which acts to retain the fence wire in the opening during use of the fence post 100 to support a wire fence. That is, the primary slot 120 connects a first point 126 located on the first end 112 of the opening 110 continuously with a second point 128 located on the second end 116 of the opening, wherein the first point is diametrically opposed to the second point.

The body portion 102 includes a plurality of openings 110 extending transversely across the body portion at intervals spaced along the length of the body portion. These intervals may be regular or may be specifically spaced to permit a single fence post configuration to be used with a variety of fencing wire types. For instance, regular spacing of the openings 110 is ideal for a plain wire or barbed wire fence. However, the fence posts of the present invention are particularly advantageous for use in relation to ring-lock fence wire since a plain strainer wire is not required as in the case of conventional timber or steel posts. Therefore, the intervals between the openings 110 may be specifically adapted to provide the ideal spacing for the top and bottom of a length of ring-lock fencing wire or alternatively for several of or even each horizontal wire in the ring-lock fencing wire mesh. Where the fencing wire to be used is barbed wire, the primary slot 120 may further include in a region central thereto, an aperture for receiving the barb.

In view of the configuration described, a generally twisting motion in the vertical plane is required by an operator to insert the fence wire into the primary slot 120, and subsequently removably secure it in the opening 110 extending through the body portion 102. Similarly, if the fence wire is required to be removed from the fence post 100, then the reverse twisting motion would free the fence wire from the fence post. However, during ordinary use, the configuration of the opening 110 and primary slot 120 in combination, will substantially retain the fence wire therein thereby providing a simple means of erecting a wire fence, and allowing the fence wire to be continuously slideable within the opening which makes it possible to simply strain the wire fence post erection.

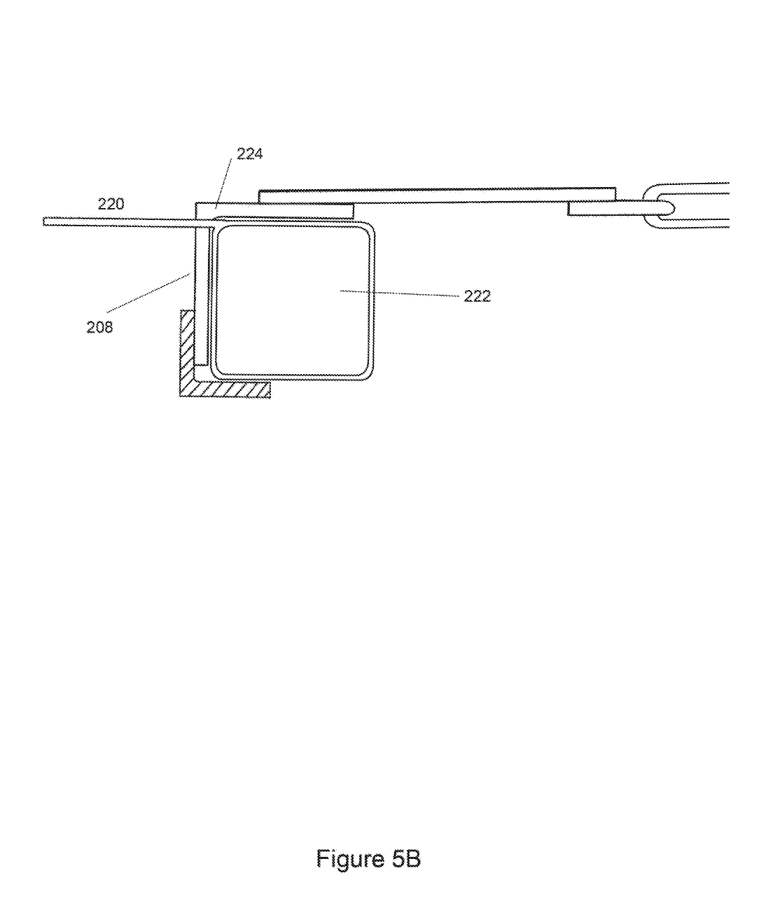

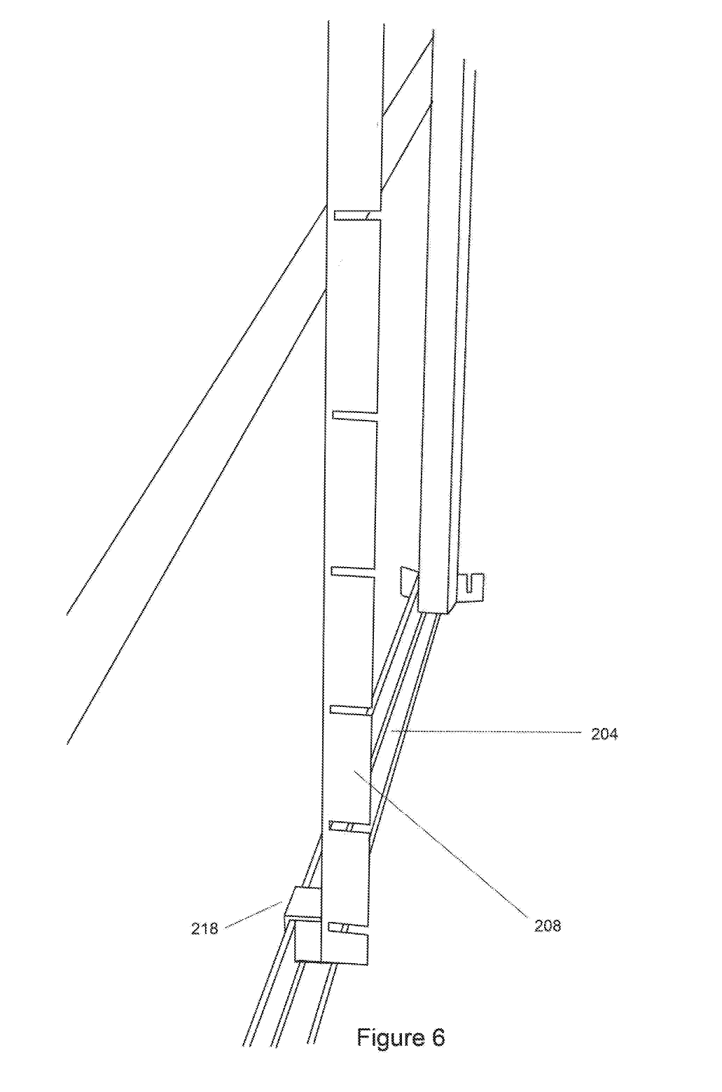

Accordingly, the fence post 100 negates the need to thread the fencing wire through the body portion 102 from the first end 112 of the opening 110 to the second end 116 thereof. This significantly enhances the speed with which a wire fence can be erected using the fence posts 100 of the present invention and also makes it possible to maintain a substantially constant tension over the life of the wire fence as will be described with more detail in relation to FIGS. 5 and 6 to follow.

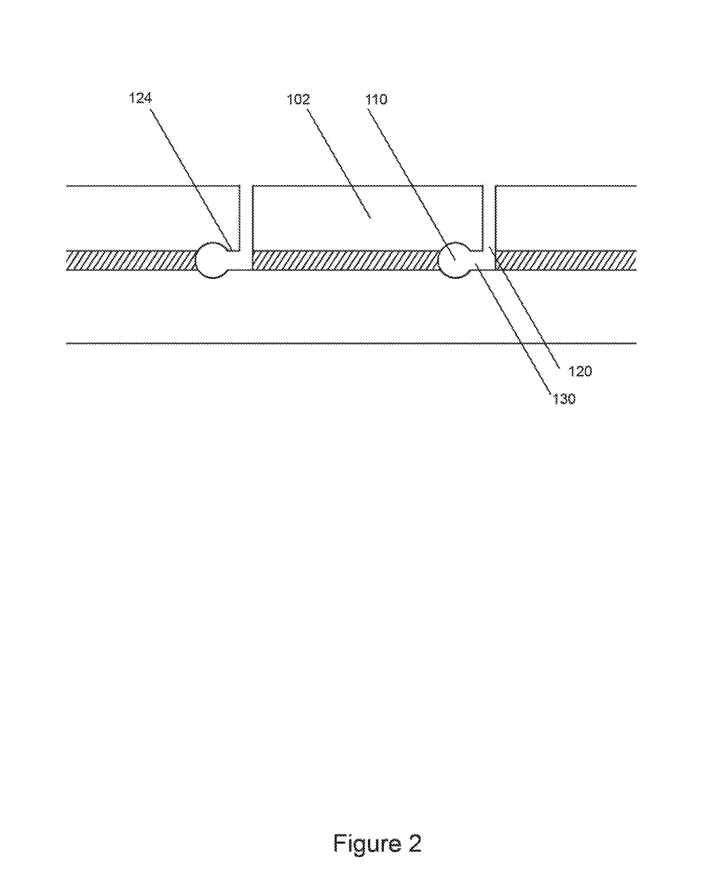

Referring now to FIG. 2, the tabs 124 formed by the body portion material and acting to retain the fence wire (not shown) in the opening 110 during use can be made more substantial by connecting the primary slot 120 to the first and second ends 112, 116 of the opening via a secondary slot 130 extending perpendicular to the primary slot 120. These secondary slots 130 extend axially along the external surface 106 of the body portion 102. In one embodiment, the secondary slots 130 extend substantially along the length of the fence post 100, i.e. along the external surface 106 of the body portion 102.

The suitable dimension of the secondary slot 130 may vary depending on the dimensions of the fence post 100 or body portion 102, and also the variety of fence wire that the slot is configured to engage. However, generally a depth of equal to or less than 10 mm is considered appropriate for the secondary slot.

The body portion 102 may be formed of any suitable material. One such material may be a moulded polymeric material, e.g. recycled plastic. This material selection ensures that the fence posts 100 are relatively light weight. However, it is to be understood that the fence post 100 having the configuration of the present invention may be formed of any suitable material such as timber, concrete or steel. Where the body portion 102 is formed of plastic the fence post may be formed of composite materials, i.e. having the polymeric body portion configured so as to be received in a steel extrusion 132 substantially the length of the body portion. The external surface 106 of the body portion 102 including the opening 110 and primary slot 120 should remain exposed. The steel extrusion 132 provides additional strength and support to the body portion 102 to ensure that the fence post 100 has a strength that is at least comparable to a conventional steel post.

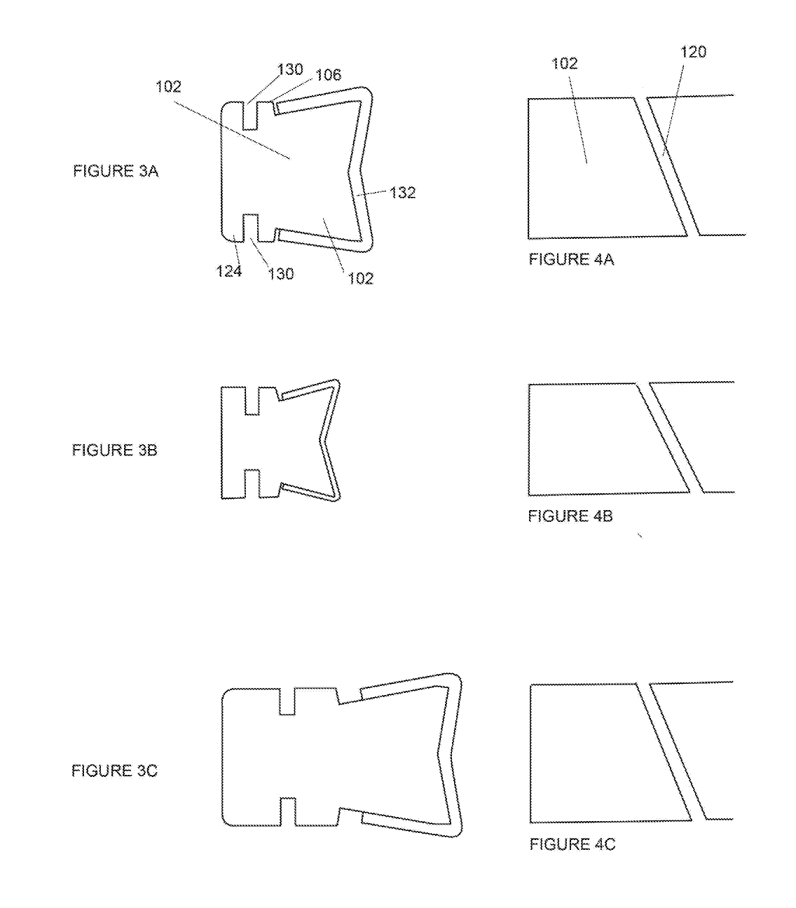

Referring now to FIGS. 3A to 3C, there are shown cross sectional view of the fence post 100 of the present invention. FIG. 3A shows the body portion 102 having a configuration adapted to act as an ordinary fence post, for example to use in place of a steel picket. The cross sectional view clearly shows the secondary slots 130 extending axially along the external surface 106 of the body portion 102. Tabs 124 are formed by the body portion and the secondary slot 130 to retain the fence wire (not shown) in the opening 110. The body portion 102 is received in a steel extrusion 132 to provide additional strength and support to the fence post 100.

FIGS. 3B and 3C show different configurations, FIG. 3B showing a dropper type fence post and FIG. 3C showing a FIG. 3B. Both the dropper type fence post shown in FIG. 3B and the FIG. 3B shown in FIG. 3C share substantially the same configuration as the fence post shown in FIG. 3A.

FIGS. 4A to 4C correspond to FIGS. 3 A and 3C respectively and show a top down view of the primary slot 120 configured to receive fencing wire therein to be guided towards the opening. In the illustrated embodiment, the primary slot 120 slants across the body portion 102 as previously described with reference to FIG. 2. The degree of the slant angle can be modified to suit various configurations of fencing wire, but will generally be in the range of 20 to 30 degrees.

Referring now to FIGS. 5A, 5B and 6, there is further provided a fencing system which includes a plurality of fence posts 100 as described with reference to FIGS. 1 through 4C. In addition to the fence posts 100 which have the particular advantage that the fence wire can slide through the openings 110 in the posts and accordingly is not permanently or temporarily fixed to any particular fence post per se, there is further provided at least one end assembly 200. The end assembly 200 includes a first vertical member 202 which is configured to secure the end assembly in a desired position. This might be for example by ramming the base of the first vertical member 202 into the ground in the usual manner, or alternately by securing the first vertical member to a fixed structure. Examples of suitable fixed structures may include buildings, trees or fence posts. In this case, the first vertical member 202 is provided with attachment means for that purpose.

The end assembly 200 further includes a support structure configured to maintain an upright position of the first vertical member 202 while in use. The support structure comprises a substantially horizontal member 204 connected to a sloping member 206 to form a substantially triangular configuration between the first vertical member 202 and the support structure 204, 206 as shown in FIG. 5A.

The end assembly 200 also includes a second vertical member 208 which is configured to be movable in axial relation to the first horizontal member 202. A series of slots 210 are provided along the length of the second vertical member 208, the slots being configured to receive fencing wire. When the end of a length of wire fence is secured proximal to the second vertical member 208, the end assembly 200 can be used to strain the entire length of wire fence with a single pull of the second vertical member towards the first vertical member 202. This is since none of the fencing wires are required to be secured or otherwise fixed to any of the fence posts supporting the wire fence along its length but can move freely through the fence posts. Tension of the wire fence can therefore be maintained from a single point.

Referring now to FIG. 5B, the end of the length of wire fence may be secured proximal to the second vertical member 208 by any suitable means. One such means involves wrapping the ends of each length of fencing wire 220, or ring-lock fencing wire around a post 222 which is then retained in a section of angle iron 224 or similar comprising the second vertical member 208. The second vertical member 208, as described above has slots 210 provided along its length to receive fencing wire 220.

The second vertical member 208 further includes a first attachment point 212 located proximal to an elbow portion 214 formed at the junction of two members 216, 218 extending laterally from the second vertical member 208. This attachment point 212 is directed towards the first vertical member 202, and a connector 214 is joined between the first attachment point and a second attachment point located on the first vertical member. The connector 214 is adjustable in length to bring about an increase or decrease in tension along the length of wire fence. The connector 214 may comprise a chain-like member for example.

Alternatively, a similar effect could be achieved by using a ratchet mechanism at the base of an elongate reel mounted on or near the second vertical member, whereby the ratchet mechanism provides the means by which the length of wire fence can be tensioned from a single point.

Referring now to FIG. 6, the second vertical member 208 includes at its base a guide portion 218 configured to mount at least a portion of the substantially horizontal member 204. This guide portion 218 maintains stability of the end assembly 200 and guides movement of the second vertical member 208 during straining of the length of wire fence.

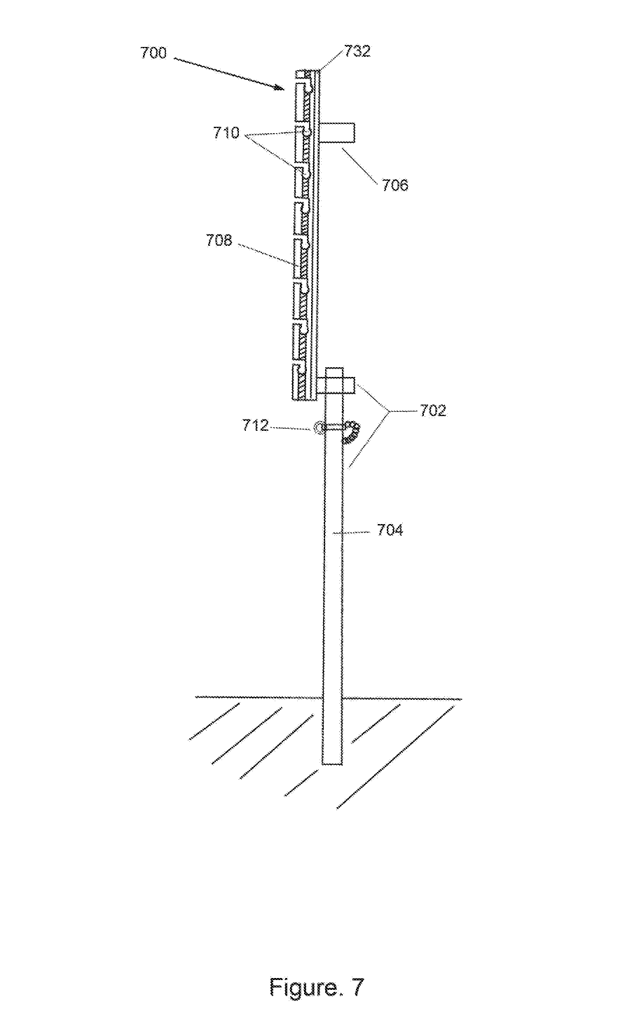

Referring now to FIG. 7, there is shown one particular embodiment of the fence post shown in FIGS. 1 to 4C, wherein the fence post 700 is specifically adapted to be used on flood prone land. The fence post 700 further includes an extender portion 702, which may be comprised of at least three portions, a first portion 704 which is embedded in the ground, and second and third movable portions 706 which extend the height of the fence post. The body portion 708 previously described, having the one or more continuous openings 710 extending transversely across the body portion, and a primary slot connecting the first and second ends of the opening to the external surface of the body portion (as shown in FIGS. 1 to 4C), has the second and third movable portions 706 of the extender portion 702 secured thereto. For instance, where the body portion 708 is received in a steel extrusion 732 substantially the length of the body portion, second and third movable portions can comprise a section of box tube or similar. During a flood event, the height of the body portion 708, which carries the fencing wires is adjusted by sliding the second movable portions 706 along the first portion 704 to give the fence extra height. In most flood events, this extra height is sufficient to lift the fencing wires out of the way of the flood waters and permit it to be easily restored to its original position once flood waters recede. In this configuration, the second and third movable portions act to secure the body portion 708 to the first portion 704. The second movable portions 706 are retained in the extended position by means of a releasable pin 712 or similar mechanism.

In a further embodiment (not shown), the fence post of the present invention is configured to be used in a temporary fencing system. In this case, the body portion further includes a vertical slot in its front fact, the vertical slot configured to receive one of a plurality of vertical wires found in a length of ring-lock fencing wire. The fence post is configured to be readily movable rather than driven into the ground, by means of a weighted base, such as a concrete block or similar. In this manner, a temporary ring-lock fence can be erected, with the weighed base provide some support to the fence post and the vertical wire in the ring-lock fencing wire further stabilising the temporary fence, by ameliorating the tendency for side to side movement of the fence post in the vertical plane.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

The present application may be used as a basis or priority in respect of one or more future applications and the claims of any such future application may be directed to any one feature or combination of features that are described in the present application. Any such future application may include one or more of the following claims, which are given by way of example and are non-limiting in regard to what may be claimed in any future application.

1. A fence post including:
(a) a body portion having an external surface and a longitudinal axis extending substantially the length of the fence post;
(b) at least one continuous opening extending transversely across the body portion, the opening having a first end and a second end, the first end being located proximal to a first side of the body portion and the second end being located proximal to a second side of the body portion which opposes the first side of the body portion,
wherein the first and second ends of the opening are connected to the external surface of the body portion via a primary slot.

2. A fence post according to claim 1, wherein the primary slot slants across the body portion relative to the opening.

3. A fence post according to claim 1, wherein the primary slot slants across the body portion such that the primary slot connects a first point located on the first end of the opening continuously with a second point located on the second end of the opening, wherein the first point is diametrically opposed to the second point.

4. A fence post according to claim 1, wherein the primary slot connecting the first and second ends of the opening is configured to receive a fencing wire therein.

5. A fence post according to claim 1, wherein the primary slot is connected to the first and second ends of the opening via a secondary slot extending substantially perpendicular to the primary slot.

6. A fence post according to claim 1, wherein the primary slot is connected to the first and second ends of the opening via secondary slots extending axially along the external surface of the body portion.

7. A fence post according to claim 5, wherein the secondary slots extend substantially along the length of the fence post along the external surface of the body portion.

8. A fence post according to claim 5, wherein the secondary slots have a depth of equal to or less than 10 mm.

9. A fence post according to claim 1, wherein the body portion includes a plurality of openings extending transversely across the body portion at intervals spaced along the length of the body portion.

10. A fence post according to claim 1, wherein the primary slot is of sufficient width to permit fencing wire to be inserted through the primary slot into the opening.

11. A fence post according to claim 1, wherein the body portion is formed of moulded polymeric material.

12. A fence post according to claim 11, wherein the body portion is configured to be received in a steel extrusion substantially the length of the body portion, such that the external surface of the body portion including the opening and primary slot remains exposed.

13. A fence post including:
(a) a body portion having a an external surface and a longitudinal axis extending substantially the length of the fence post;
(b) at least one continuous opening extending transversely across the body portion, the opening being configured to receive a fencing wire therein in use, without requiring the fencing wire to be threaded through the opening from a first end of the opening being located proximal to a first side of the body portion to a second end of the opening being located proximal to a second side of the body portion which opposes the first side of the body portion;
wherein the configuration of the opening further provides sufficient hold on the fencing wire to prevent it from escaping the opening while the fence post is in use.
